(19) United States
(12) Patent Application Publication
(10) Pub. No.: US 2018/0298304 A1
(43) Pub. Date: Oct. 18, 2018

(54) GREASE COMPOSITION, AND ROLLING DEVICE FOR VEHICLE

(71) Applicants: JTEKT CORPORATION, Osaka-shi, Osaka (JP); JXTG NIPPON OIL & ENERGY CORPORATION, Tokyo (JP)

(72) Inventors: Koji YOSHIZAKI, Higashiosaka-shi (JP); Hiroshi INUKAI, Ikoma-gun (JP); Yoichiro SANKAI, Kashiwara-shi (JP); Shinji YAMANE, Kashiba-shi (JP); Hideo SHIBATA, Kashiba-shi (JP); Hirofumi INOUE, Ikoma-gun (JP); Ryuji NAKATA, Osaka-shi (JP); Kazumi SAKAI, Tokyo (JP); Kentaro YAMAGUCHI, Tokyo (JP); Kiyomi SAKAMOTO, Tokyo (JP)

(73) Assignees: JTEKT Corporation, Osaka-shi, Osaka (JP); JXTG Nippon Oil & Energy Corporation, Tokyo (JP)

(21) Appl. No.: 15/580,127

(22) PCT Filed: Jun. 9, 2016
(86) PCT No.: PCT/JP2016/067240

§ 371 Date: Dec. 6, 2017

(30) Foreign Application Priority Data
Jun. 12, 2015 (JP) 2015-119099

(51) Int. Cl. C10M 169/06; F16C 33/66; C10M 107/02; C10M 115/08; C10M 141/10

(52) U.S. Cl. CPC C10M 169/06; F16C 33/6633; C10M 107/02; C10M 115/08; C10N 2020/02; C10M 2223/04; C10M 2203/1025; C10M 2215/1026; C10M 141/10

(57) ABSTRACT

Provided is a grease composition containing a base oil, a thickener, and an additive. The base oil contains a poly-α-olefin and has a kinematic viscosity of 20-60 mm²/s at 40° C. The thickener contains a urea compound produced by reacting a diisocyanate compound with a mixed amine containing an alicyclic amine and an aromatic amine. The additive contains a phosphorous acid ester, an ether compound, and an oxidized paraffin.

### TECHNICAL FIELD

One aspect of the present invention relates to a grease composition, and a rolling device for a vehicle in which the grease composition is enclosed as a lubricant.

### BACKGROUND ART

In background art, a grease composition disclosed in Patent Literature 1 or Patent Literature 2 has been known as a lubricant for use in a bearing of a car or the like.

Patent Literature 1 discloses a grease composition containing a base oil, a thickener, and an additive. The base oil includes at least one oil selected from an ether oil, an ester oil, and a synthetic hydrocarbon oil. The base oil has kinematic viscosity of 15 mm²/s to 200 mm²/s. The additive includes a poly(meth)acrylate.

Patent Literature 2 discloses a grease composition containing a thickener, a base oil, and an amine phosphate.

### CITATION LIST

### Patent Literature

Patent Literature 1: JP 2006-169441 A
Patent Literature 2: WO 2014/092201 A1

### SUMMARY OF THE INVENTION

### Technical Problems

Grease to be used is selected depending on its use conditions (kind of machine, operating conditions, service temperature range, etc.). For example, grease containing a middle-viscosity base oil having kinematic viscosity of about 70 to 100 mm²/s (40° C.) is used as grease for a hub unit of a car. Such a kind of grease contributes to prevention of seizure in a bearing of the hub unit or a lubrication life of the bearing maintained for a long time.

On the other hand, in recent years, excellent fuel economy has been required for cars due to growing interest in global warming, etc.

In order to improve the fuel economy, it is necessary to use a low-viscosity base oil as grease to thereby make frictional resistance in a sliding part (raceway contact part) of a bearing as low as possible. However, when the low-viscosity base oil is simply used, it is difficult as antinomy to maintain the seizure resistance or the long-time lubrication life of the bearing.

In addition, with expansion of the car market to cold districts over the world, there are concerns that low-temperature fretting may be generated in a sliding part of a bearing due to vibration during transportation. Under a low temperature environment, grease may be solidified easily so that a base oil of the grease cannot spread to the sliding part.

Therefore, an object in one aspect of the present invention is to provide a grease composition capable of both reducing frictional resistance in a sliding part and maintaining seizure resistance and a long-time lubrication life, and capable of reducing occurrence of fretting under a low-temperature environment, and a rolling device for a vehicle including the grease composition.

### Solution to Problems

A grease composition in one aspect of the present invention for solving the above problem(s) includes: a base oil containing a poly-α-olefin and having a kinematic viscosity at 40° C. of 20 to 60 mm²/s; a thickener containing an urea-based compound obtained by reaction of a mixed amine of an alicyclic amine and an aromatic amine with a diisocyanate compound; and an additive, and the additive includes a phosphorous acid ester, an ether-based compound, and a paraffin oxide (first embodiment).

In the grease composition in one aspect of the present invention, the base oil preferably has a traction coefficient of 0.02 or less; and the base oil preferably has a pour point of −50° C. or less (second embodiment).

In the grease composition in one aspect of the present invention, the ether-based compound preferably has a polar group at a molecular terminal, the polar group having a 5-membered ring including at least one hetero atom (third embodiment).

The grease composition in one aspect of the present invention preferably includes the thickener in an amount of 10 mass % to 25 mass %, the phosphorous acid ester in an amount of 0.2 mass % to 5 mass %, the ether-based compound in an amount of 0.2 mass % to 5 mass %, and the paraffin oxide in an amount of 0.5 mass % to 10 mass % (fourth embodiment).

A rolling device for a vehicle in one aspect of the present invention includes the grease composition according to one aspect of the present invention, the grease composition being enclosed as a lubricant in the rolling device (fifth embodiment).

### Advantageous Effects of the Invention

According to a rolling device for a vehicle including the grease composition in one aspect of the present invention, frictional resistance of a shaft supported by a bearing can be reduced to reduce rotational torque. It is therefore possible to improve fuel economy of the vehicle. Not to say, it is possible to maintain seizure resistance and a long-time lubrication life of the bearing, and it is also possible to reduce occurrence of fretting when the vehicle is transported (for example, by rail, truck or the like) in a cold district.

### BRIEF DESCRIPTION OF THE DRAWINGS

FIG. 1 is a sectional view of a hub unit according to an embodiment of the present invention.

FIG. 2 is a perspective view of a flange portion of the hub unit.

FIG. 3 is a front view of the flange portion.

FIG. 4 is a diagram showing a configuration of a low-temperature fretting tester.

### DESCRIPTION OF EMBODIMENTS

A grease composition in one aspect of the present invention contains a base oil, a thickener, and an additive.

A synthetic oil containing a poly-α-olefin and having a kinematic viscosity at 40° C. of 20 to 60 mm²/s is used as the base oil.

Preferably, physical properties of the base oil are within the following ranges. That is, kinematic viscosity (in accordance with JIS K 2283) is 20 to 60 mm²/s (40° C.), and preferably 25 to 55 mm²/s (40° C.). When the kinematic viscosity of the base oil falls within the aforementioned range, frictional resistance in a sliding part of a bearing can be reduced in comparison with a grease composition using a base oil having a kinematic viscosity of about 70 to 100 mm²/s (40° C.). In addition, a pour point (in accordance with JIS K 2269) is preferably −50° C. or less, and more preferably −70° C. to −50° C. When the pour point of the base oil falls within the aforementioned range, it is possible to ensure fluidity of the grease composition at a low-temperature environment (for example, −40° C. or less). It is therefore possible to easily spread the base oil to the sliding part of the bearing. Accordingly, it is possible to improve an effect of suppressing low-temperature fretting. In addition, a traction coefficient is 0.02 or less, and preferably 0.001 or more and 0.01 or less. When the traction coefficient of the base oil falls within the aforementioned range, it is possible to reduce torque of the grease.

Typical examples of the poly-α-olefin may include oligomers or co-oligomers of α-olefin each having 2 to 32 carbon atoms, and preferably 6 to 16 carbon atoms (such as 1-octen oligomer, decene oligomer, ethylene-propylene oligomer, etc.), and hydrides thereof.

In addition, the content of the base oil is preferably 60 mass % to 90 mass % and more preferably 65 mass % to 88 mass %, based on the total amount of the grease composition.

An urea-based compound obtained by reaction of a mixed amine of an alicyclic amine and an aromatic amine with a diisocyanate compound is used as the thickener. Examples of the urea-based compound may include an urea compound such as a diurea compound, a triurea compound, a tetraurea compound, a polyurea compound (excluding the diurea compound, the triurea compound and the tetraurea compound), etc., an urea-urethane compound, an urethane compound such as diurethane, a mixture of those compounds, etc. Of them, the diurea compound is preferred. Any urea compound using such a combination can reduce occurrence of fretting.

Examples of the alicyclic amine may include cyclohexylamine, dicyclohexylamine, etc., and examples of the aromatic amine may include aniline, p-toluidine, etc.

Further, examples of the diisocyanate compound may include aliphatic diisocyanate, alicyclic diisocyanate, aromatic diisocyanate, etc. Examples of the aliphatic diisocyanate may include diisocyanate with saturated and/or unsaturated linear or branched hydrocarbon groups, such as octadecane diisocyanate, decane diisocyanate, hexane diisocyanate (HDI), etc. In addition, examples of the alicyclic diisocyanate may include cyclohexyl diisocyanate, dicyclohexyl methane diisocyanate, etc. In addition, examples of the aromatic diisocyanate may include phenylene diisocyanate, tolylene diisocyanate (TDI), diphenyl diisocyanate, diphenyl methane diisocyanate (MDI), etc.

Further, when the mixed amine of the alicyclic amine and the aromatic amine is used as a raw material of the urea-based thickener, a mixing ratio (mass ratio) of the alicyclic amine to the aromatic amine is preferably alicyclic amine:aromatic amine=55:45 to 99:1, and more preferably 60:40 to 95:5.

The mixed amine and the diisocyanate can be reacted with each other by various methods and under various conditions. It is preferable that the mixed amine and the diisocyanate are reacted in the base oil, because a diurea compound in which the thickener is uniformly dispersed can be obtained. In addition, the reaction may be performed in such a manner that the base oil in which the diisocyanate compound has been dissolved is added into the base oil in which the mixed amine has been dissolved, or in such a manner that the base oil in which the mixed amine has been dissolved is added into the base oil in which the diisocyanate compound has been dissolved. Temperature and time in such a reaction are not limited especially, but may be similar to those in such a reaction performed typically. The reaction temperature is preferably 60° C. to 170° C. in terms of dissolubility and volatility of the mixed amine and the diisocyanate. The reaction time is preferably 0.5 to 2.0 hours in terms of completion of reaction of the mixed amine and the diisocyanate, and enhancement of efficiency led by reduction in manufacturing time.

In addition, the content of the thickener is preferably 10 mass % to 25 mass % and more preferably 12 mass % to 23 mass %, based on the total amount of the grease composition.

Examples of the additive may include a phosphorous acid ester, an ether-based compound, and a paraffin oxide as essential components, and various additives such as an extreme pressure additive, a rust-preventing additive, an antioxidant, an antiwear additive, a dye, a color stabilizer, a viscosity improver, a structure stabilizer, a metal deactivator, and a viscosity index improver may be added as optional components. As the extreme pressure additive, a sulfur-based compound (such as zinc dithiocarbamate (ZnDTC)), a chlorine-based compound (such as chlorinated paraffin), an organic Mo compound such as molybdenum dithiocarbamate (MoDTC) or molybdenum dithiophosphate (MoDTP)), etc. may be used as an optional component.

Examples of the phosphorous acid ester may include triisopropyl phosphite, diisopropyl phosphite, diphenyl hydrogen phophite, etc. Particularly, diphenyl hydrogen phosphite is preferred.

In addition, the content of the phosphorous acid ester is preferably 0.2 mass % to 5 mass % and more preferably 0.3 mass % to 4 mass %, based on the total amount of the grease composition.

The ether-based compound is used as an essential component. An ether-based compound having a polar group at a molecule is preferably used as the ether-based compound. More preferably, an ether-based compound having a polar group at a molecular terminal is used as the ether-based compound. Particularly preferably, an ether-based compound having a polar group at a molecular terminal, the polar group having a 5-membered ring including at least one hetero atom, is used as the ether-based compound. When the ether-based compound has a polar group, the polar group is easily attracted and adsorbed by a surface film formed by reaction with a raceway surface (metal surface) of the bearing and derived from the phosphorous acid ester having polarity. It is therefore possible to form an oily film of the ether-based compound well on the surface film of the phosphor-based compound.

For example, a sulfolane derivative expressed by the following general formula (1) can be used as the ether-based compound having, at a molecular terminal, a polar group having a 5-membered ring including at least one hetero atom.

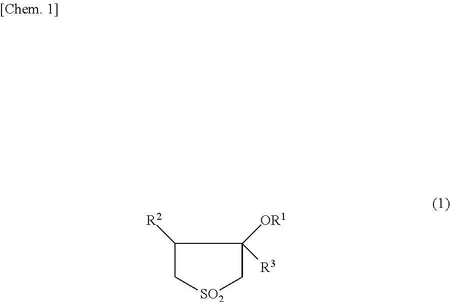

(In the formula, R¹ is a hydrocarbon group having 1 to 20 carbon atom(s), and each of R² and R³ is a hydrogen atom or a hydrocarbon group having 1 to 20 carbon atom(s).)

In addition, the content of the ether-based compound is preferably 0.2 mass % to 5 mass % and more preferably 0.5 mass % to 4 mass %, based on the total amount of the grease composition.

The paraffin oxide is used as an essential component. Examples of the paraffin oxide may include paraffin oxide obtained by oxidation of petroleum-based wax such as paraffin wax or microcrystalline wax, synthetic wax such as polyethylene wax, etc. In addition, the content of the paraffin oxide is preferably 0.5 mass % to 10 mass % based on the total amount of the grease composition.

The grease composition in one aspect of the present invention can be, for example, obtained as follows. That is, the base oil, the urea-based thickener, the phosphorous acid ester, the ether-based compound and the paraffin oxide as essential components, and other additives if necessary, are mixed, stirred and then passed through a roll mill or the like.

Next, a hub unit 1 in which the grease composition in one aspect of the present invention is enclosed as grease (G) will be described with reference to the accompanying drawings.

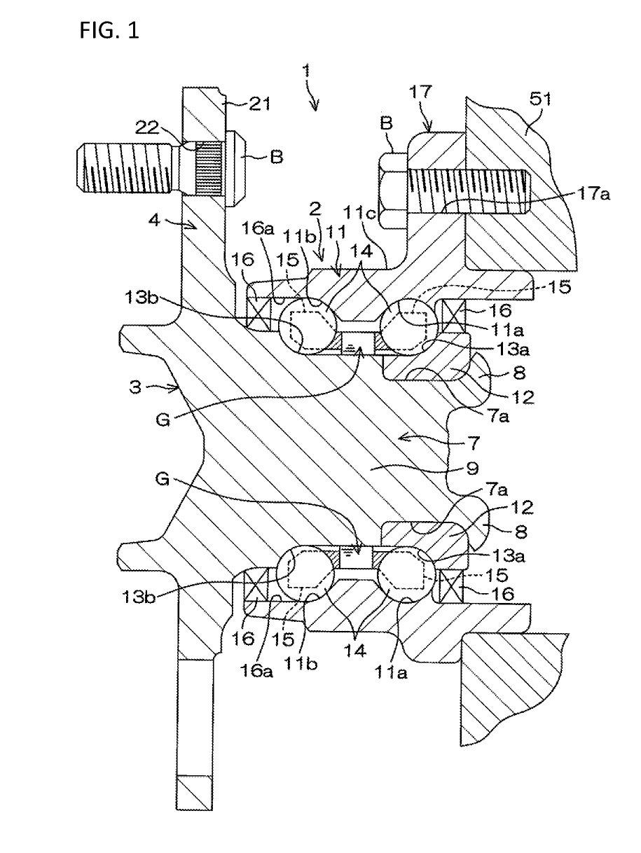

FIG. 1 is a sectional view of a hub unit 1 according to an embodiment of the present invention. The left/right direction of FIG. 1 will be referred to as an axial direction of the hub unit 1, while the left side of FIG. 1 will be referred to as an axially outer side, and the right side of FIG. 1 will be referred to as an axially inner side.

For example, the hub unit 1 supports a wheel of a car rotatably on a vehicle-body-side suspension device. The hub unit 1 includes a rolling bearing 2, a hub wheel 3 serving as a bearing ring member of the rolling bearing 2, and an annular flange portion 4 provided integrally with the hub wheel 3. Raw materials of the hub wheel 3 and the flange portion 4 in this embodiment are, for example, formed by hot forging.

The hub wheel 3 includes a small diameter portion 7, a caulking portion 8, and a large diameter portion 9. The small diameter portion 7 has a circular shape in section. In the caulking portion 8, an axially inner end portion of the small diameter portion 7 is bent and deformed radially outward. The large diameter portion 9 has a circular shape in section with a larger diameter than the small diameter portion 7 and is provided continuously and axially outward from the small diameter portion 7. In the large diameter portion 9 of the hub wheel 3, the flange portion 4 is bent and formed to extend radially outward from an outer circumferential surface of the large diameter portion 9.

The rolling bearing 2 is, for example, a double-row ball bearing, which includes an outer ring 11 and an inner ring member 12. The outer ring 11 has a pair of outer ring raceway surfaces 11a and 11b in its inner circumferential surface. The inner ring member 12 is inserted and fitted so that an inner circumferential surface of the inner ring member 12 can come in close contact with an outer circumferential surface 7a of the small diameter portion 7 of the hub wheel 3. The inner ring member 12 has an inner ring raceway surface 13a in its outer circumferential surface. The inner ring raceway surface 13a is opposed to the outer ring raceway surface 11a located on the axially inner side. The large diameter portion 9 of the hub wheel 3 has an inner ring raceway surface 13b in its outer circumferential surface. The inner ring raceway surface 13b is opposed to the outer ring raceway surface 11b on the axially outer side.

In addition, the rolling bearing 2 includes a plurality of balls (rolling elements) 14, and a pair of cages 15. The balls 14 are disposed in two rows rollably between the outer ring raceway surface 11a and the inner ring raceway surface 13a and between the outer ring raceway surface 11b and the inner ring raceway surface 13b respectively. The balls 14 disposed in two rows are retained at predetermined circumferential intervals by the pair of cages 15 respectively.

In addition, the rolling bearing 2 includes a seal member 16. An annular space formed by the hub wheel 3 and the outer ring 11 is sealed from axially opposite ends of the rolling bearing 2 by the seal member 16. In the annular space 16a sealed by the seal member 16, the grease G composed of the aforementioned grease composition is enclosed.

Further, the rolling bearing 2 has a bearing flange 17 extending radially outward from the outer circumferential surface 11c of the outer ring 11. A plurality of bolt holes 17a are formed in the bearing flange 17 so as to penetrate the bearing flange 17 in its thickness direction. Bolts B are inserted into the bolt holes 17a, and screwed down to knuckles 51 of the suspension device. Thus, the bearing flange 17 is fixed to the knuckles 51.

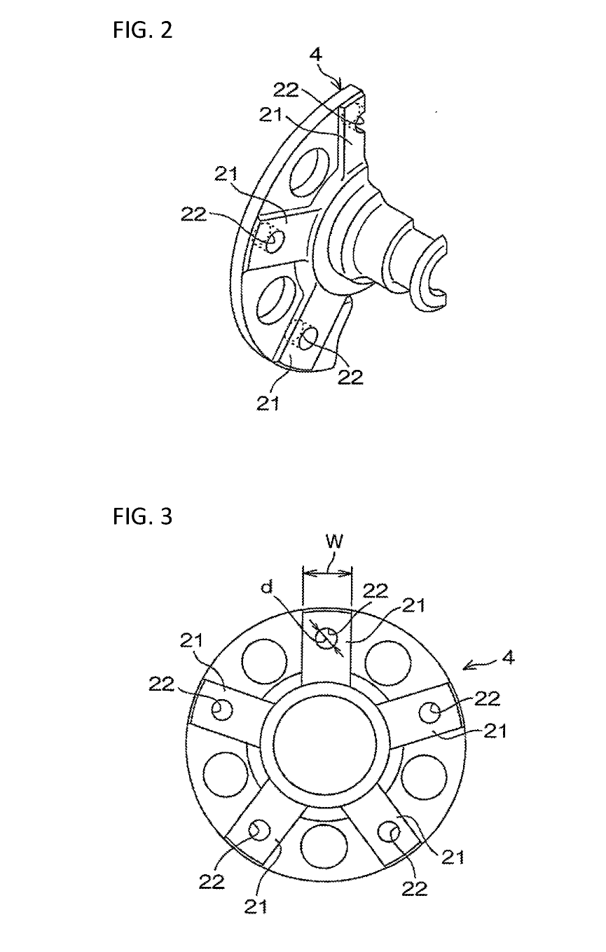

FIG. 2 is a perspective view of the flange portion 4. FIG. 3 is a front view of the flange portion 4.

In FIG. 2 and FIG. 3, the flange portion 4 has a plurality (five in the embodiment) of thick portions 21 formed at predetermined intervals in the circumferential direction of the flange portion 4. Each thick portion 21 is formed so that an axially inner end surface of the thick portion 21 can be raised, while the thick portion 21 is formed to extend radially in the radial direction in front view of FIG. 3. In addition, each thick portion 21 has a predetermined width W in the circumferential direction (hereinafter referred to as circumferential width W).

A bolt hole 22 is formed on the radially outer side of each thick portion 21 so as to penetrate the thick portion 21 in the thickness direction and at a substantially central portion of the circumferential width W. A hub bolt B for attaching a wheel or a brake disc is fixed to each bolt hole 22 by press fitting, as shown in FIG. 1. Accordingly, a diameter d (see FIG. 3) of the bolt hole 22 is set at a dimension with which the hub bolt B can be press-fitted into the bolt hole 22.

In this manner, according to the hub unit 1, the phosphorous acid ester (extreme pressure additive) in the grease (G) has good adsorptivity to metal. It can be therefore considered that a surface film formed of a compound (such as iron phosphate (II)) derived from the phosphorous acid ester is formed in the outer ring raceway surface 11a and the inner ring raceway surface 13a of the rolling bearing 2 due to reaction with the metal. Further, the surface film has polarity based on P═O bonding of the iron phosphate (II). Accordingly, polar groups (sulfolane groups) of the ether-based compound (oily agent) is attracted and adsorbed to the surface film well. As a result, it can be considered that an oily film of the ether-based compound is formed on the surface film.

The outer ring raceway surface 11a and the inner ring raceway surface 13a are thinly coated with the surface film of the phosphorous acid ester. It can be therefore considered that, even when vibration occurs in a state where the base oil has not spread to the outer ring raceway surface 11a or the inner ring raceway surface 13a yet, it is possible to prevent contact of the metal between the surface of each ball 14 and the outer ring raceway surface 11a or the inner ring raceway surface 13a or to reduce impact by the contact. Accordingly, fretting under a low-temperature environment (low-temperature fretting) can be reduced. Thus, occurrence of fretting can be reduced when a vehicle is transported (for example, by rail, truck or the like) in a cold district.

Further, when the rolling bearing 2 is rotating, lubrication by the oily film derived from the base oil drawn in a space between the surface of each ball 14 and the outer ring raceway surface 11a or the inner ring raceway surface 13a can be assisted by the oily film of the ether-based compound. That is, even when the oily film of the base oil is thin, the seizure resistance and long-time lubrication life of the sliding part can be maintained by cooperation with the oily film of the ether-based compound. As a result, the base oil can be selected on the basis of its kinematic viscosity. Therefore, when oil having low kinematic viscosity is used as the base oil, frictional resistance in the sliding part can be reduced. Thus, the frictional resistance of the shaft supported by the rolling bearing 2 can be reduced to reduce the rotational torque, and thus, the fuel economy of the vehicle can be improved.

The present invention is not limited to the aforementioned embodiment but may be carried out along another embodiment.

For example, although an example in which the grease (G) is enclosed in the rolling bearing 2 constituted of a (double-row) ball bearing has been described in the aforementioned embodiment, a bearing in which a grease constituted of a grease composition is enclosed in one aspect of the present invention may be another rolling bearing such as a needle bearing or a roller bearing using other members than the balls as rolling elements.

In addition, a bearing in which a grease constituted of a grease composition is enclosed in one aspect of the present invention may be mounted on a rolling device for a vehicle other than the aforementioned hub unit 1, for example, a suspension unit, a steering unit, etc.

Further, various changes on design can be made within the scope described in the claim(s).

### EXAMPLES

Next, one aspect of the present invention will be described based on examples and comparative examples. However, the present invention is not limited to the following examples.

### Examples 1 to 4 and Comparative Examples 1 to 9

### <Preparation of Grease>

A thickener, a base oil and additives were mixed at each mixing ratio shown in Table 1 for each of the examples and the comparative examples, and thus, each grease composition for testing was prepared. The obtained grease compositions for testing were subjected to the following evaluation. Evaluation results are shown in Table 1.

In Table 1, the kinematic viscosity of the base oil was expressed by a value measured in accordance with JIS K 2283, and the pour point of the base oil was expressed by a value measured in accordance with JIS K 2269.

### (1) Thickener

Alicyclic amine (cyclohexylamine)
Aromatic amine (p-toluidine)
Aliphatic amine (octylamine)

The amines were mixed at a mass ratio shown in Table 1, followed by reacting with a diisocyanate compound (diphenyl methane diisocyanate), thereby preparing an urea-based compound.

### (2) Base Oil

Mineral oil: kinematic viscosity of 30 mm²/s (40° C.)
PAO: kinematic viscosity of 30 to 70 mm²/s (40° C.)
Ester: dioctyl sebacate

### (3) Additives

Phosphite (diphenyl hydrogen phosphite)
Phosphate (tricresyl phosphate)
Ether-based (sulfolane derivative (which is a compound represented by the aforementioned formula (1), in which R¹ is an alkyl group having 8 carbon atoms, and R² and R³ are a hydrogen atom))
Paraffin oxide (petroleum-based oxidation wax)

### <Evaluation>

### (1) Measurement of Traction Coefficient

As for the base oil used in each of the examples and the comparative examples, a traction coefficient was measured by disk-on-roller under the conditions of a surface pressure of 0.5 GPa, a peripheral velocity of 0.5 m/sec, and a sliding ratio of 3%. Evaluation results are shown in Table 1.

### (2) Measurement of Bearing Torque

Two grams of a grease composition obtained in each of the examples and the comparative examples was enclosed in a rolling bearing (6204). The rolling bearing was rotated under the conditions of a rotational speed of 4,000 rpm, no load and a room temperature, and a torque value after 0.5 hours of rotation was measured. Evaluation results are expressed by relative values to a torque value in Comparative Example 1 as a reference value (=1).

### (3) Measurement of Frictional Coefficient

As for a grease composition obtained in each of the examples and the comparative examples, a frictional coefficient was measured by a reciprocating sliding-friction testing machine under the conditions of a surface pressure of 1.7 GPa, an amplitude of 1.5 mm, a frequency of 50 Hz, and a temperature of 40° C. The measuring time was 10 minutes, and an average value of frictional coefficients measured for the last one minute was regarded as a measured value.

### (4) Seizure Life Testing

Two grams of a grease composition obtained in each of the examples and the comparative examples was enclosed in a rolling bearing (6204ZZ). The rolling bearing was rotated under the conditions of a rotational speed of 10,000 rpm, an axial load (Fa) of 66 N, a radial load (Fr) of 66 N, and a bearing temperature of 150° C., and a period until seizure occurred was measured. Evaluation results are expressed by relative values to a period until seizure occurred in Comparative Example 4 as a reference value (=1). In Examples 1 to 4, no seizure occurred even when a period (relative value) in Table 1 had passed, and thus, a testing machine was suspended.

### (5) Separation Life Testing

One gram of a grease composition obtained in each of the examples and the comparative examples was enclosed in a rolling bearing (51110). The rolling bearing was rotated under the conditions of a rotational speed of 1,500 rpm, a radial load (Fr) of 3,375 N, and a room temperature as an atmosphere temperature, and a period until separation occurred was measured. Evaluation results are expressed by relative values to a period until separation occurred in Comparative Example 4 as a reference value (=1). In Examples 1 to 4, no separation occurred even when a period (relative value) in Table 1 had passed, and thus, a testing machine was suspended.

Further, in another separation life testing, 14 g of a grease composition obtained in each of the examples and the comparative examples was enclosed in a rolling bearing (DAC4378). The rolling bearing was rotated under the conditions of a rotational speed of 300 rpm, an axial load (Fa) of 8 kN, a radial load (Fr) of 8 kN, and a room temperature as an atmosphere temperature, and a period until separation occurred was measured. Evaluation results are expressed by relative values to a period until separation occurred in Comparative Example 4 as a reference value (=1). In Examples 1 to 4, no separation occurred even when a period (relative value) in Table 1 had passed, and thus, a testing machine was suspended.

### (6) Low-Temperature Fretting Testing

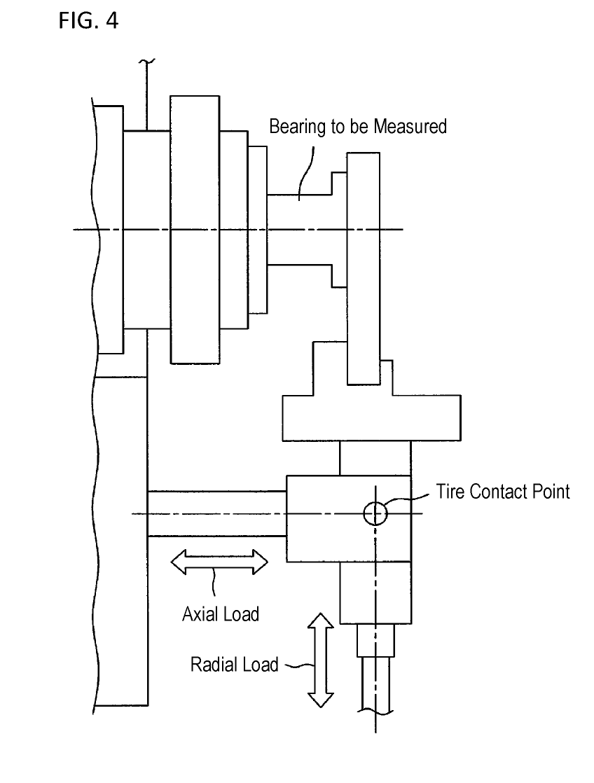

Fourteen grams of a grease composition obtained in each of the examples and the comparative examples was enclosed in a rolling bearing (DAC4378). The rolling bearing was set in a fretting tester shown in FIG. 4. The rolling bearing was oscillated under the conditions of a frequency of 4 Hz, an axial load (Fa) of ±1.4 kN, a radial load (Fr) of 5.5±4.4 kN, and a bearing temperature of −40° C. so as to reach 1,000,000 cycles in which the axial load and the radial load were shaken with the aforementioned amplitude in each cycle. Thus, depth of fretting abrasion generated in a raceway surface of the bearing was measured. Each valuation result is expressed by maximum abrasion depth generated in the raceway surface, which is expressed by a relative value to the depth of abrasion in Comparative Example 4 as a reference value (=1).

TABLE 1

| | | | | | | Comparative | Comparative |
|---|---|---|---|---|---|---|---|
| | | Example 1 | Example 2 | Example 3 | Example 4 | Example 1 | Example 2 |
| Thickener | Alicyclic amine | 70 | 70 | 90 | 70 | 100 | — |
| | Aromatic amine | 30 | 30 | 10 | 30 | — | 100 |
| | Aliphatic amine | — | — | — | — | — | — |
| | Amount (mass %) | 15 | 15 | 15 | 20 | 15 | 20 |
| Base oil | Mineral oil | — | — | — | — | — | — |
| | PAO | 81 | 81 | 81 | 76 | 81 | 76 |
| | Ester | — | — | — | — | — | — |
| Kinematic viscosity of base oil | | 30 | 50 | 30 | 30 | 30 | 30 |
| (mm²/s @40° C.) | | | | | | | |
| Additives | Phosphite | 1 | 1 | 1 | 1 | 1 | 1 |
| | Phosphate | — | — | — | — | — | — |
| | Ether-based | 1 | 1 | 1 | 1 | 1 | 1 |
| | Paraffin oxide | 2 | 2 | 2 | 2 | 2 | 2 |

| | | | | | | |
|---|---|---|---|---|---|---|
| Worked penetration (60 W) | 300 | 300 | 300 | 240 | 230 | 230 |
| Bearing torque (Comparative Example 1 = 1) | 0.6 | 0.9 | 0.7 | 0.6 | 1 | 1 |
| Pour point of base oil (° C.) | −65 | −65 | −65 | −65 | −65 | −65 |
| Traction coefficient of base oil | 0.0063 | 0.0063 | 0.0063 | 0.0063 | 0.0063 | 0.0063 |
| Frictional coefficient | 0.09 | 0.09 | 0.09 | 0.1 | 0.13 | 0.13 |
| Seizure life ratio | 1.6 | 1.6 | 1.6 | 1.6 | 1 | 0.5 |
| (Comparative Example 4 = 1) | suspended | suspended | suspended | suspended | | |
| bearing: 6204ZZ | | | | | | |
| rotational velocity: 10,000 rpm | | | | | | |
| load Fa/Fr = 66N/66N | | | | | | |
| temperature: 150° C. | | | | | | |
| Separation life ratio | 1.9 | 2 | 2 | 2 | 1 | 0.8 |
| (Comparative Example 4 = 1) | suspended | suspended | suspended | suspended | | |
| bearing: 51110 | | | | | | |
| rotational velocity: 1,500 rpm | | | | | | |
| load Fr = 3,375N | | | | | | |
| atmosphere temperature: room temperature | | | | | | |
| Separation life ratio | 2.5 | 2.5 | 2.5 | 2.5 | 1 | 0.9 |
| (Comparative Example 4 = 1) | suspended | suspended | suspended | suspended | | |
| bearing: DAC4378 | | | | | | |
| rotational velocity: 300 rpm | | | | | | |
| load Fa/Fr = 8 kN/8 kN | | | | | | |
| atmosphere temperature: room temperature | | | | | | |
| Low-temperature fretting | 0.3 | 0.5 | 0.3 | 0.3 | 0.3 | 0.3 |
| (maximum abrasion ratio: Comparative | | | | | | |
| Example 4 = 1) | | | | | | |

| | | Comparative | Comparative | Comparative | Comparative | Comparative | Comparative | Comparative |
|---|---|---|---|---|---|---|---|---|
| | | Example 3 | Example 4 | Example 5 | Example 6 | Example 7 | Example 8 | Example 9 |
| Thickener | Alicyclic amine | 70 | — | 70 | 70 | 70 | 70 | 70 |
| | Aromatic amine | 30 | 100 | 30 | 30 | 30 | 30 | 30 |
| | Aliphatic amine | — | — | — | — | — | — | — |
| | Amount (mass %) | 15 | 15 | 17 | 15 | 15 | 15 | 15 |
| Base oil | Mineral oil | — | 81 | — | — | — | — | — |
| | PAO | 81 | — | — | 82 | 81 | 83 | 82 |
| | Ester | — | — | 79 | — | — | — | — |
| Kinematic viscosity of base oil | | 70 | 70 | 30 | 30 | 30 | 30 | 30 |
| (mm²/s @40° C.) | | | | | | | | |
| Additives | Phosphite | 1 | 1 | 1 | — | — | 1 | 1 |
| | Phosphate | — | — | — | — | 1 | — | — |
| | Ether-based | 1 | 1 | 1 | 1 | 1 | 1 | — |
| | Paraffin oxide | 2 | 2 | 2 | 2 | 2 | — | 2 |

| | | | | | | | |
|---|---|---|---|---|---|---|---|
| Worked penetration (60 W) | 300 | 230 | 230 | 230 | 230 | 230 | 230 |
| Bearing torque (Comparative Example 1 = 1) | 1.2 | 1.2 | 1 | 1 | 1 | 1 | 1 |
| Pour point of base oil (° C.) | −65 | −15 | −62.5 | −65 | −65 | −65 | −65 |
| Traction coefficient of base oil | 0.0063 | 0.03 | 0.007 | 0.0063 | 0.0063 | 0.0063 | 0.0063 |
| Frictional coefficient | 0.13 | 0.13 | 0.14 | 0.13 | 0.13 | 0.09 | 0.13 |
| Seizure life ratio | 1 | 1 | 1 | 1 | 1 | 1 | 1 |
| (Comparative Example 4 = 1) | | | | | | | |
| bearing: 6204ZZ | | | | | | | |
| rotational velocity: 10,000 rpm | | | | | | | |
| load Fa/Fr = 66N/66N | | | | | | | |
| temperature: 150° C. | | | | | | | |
| Separation life ratio | 1 | 1 | 1 | 0.8 | 0.8 | 1 | 0.9 |
| (Comparative Example 4 = 1) | | | | | | | |
| bearing: 51110 | | | | | | | |
| rotational velocity: 1,500 rpm | | | | | | | |
| load Fr = 3,375N | | | | | | | |
| atmosphere temperature: room temperature | | | | | | | |
| Separation life ratio | 1 | 1 | 1.5 | 1.5 | 1.5 | 1.5 | 1.5 |
| (Comparative Example 4 = 1) | | | | | | | |
| bearing: DAC4378 | | | | | | | |
| rotational velocity: 300 rpm | | | | | | | |
| load Fa/Fr = 8 kN/8 kN | | | | | | | |
| atmosphere temperature: room temperature | | | | | | | |
| Low-temperature fretting | 0.7 | 1 | 0.3 | 0.3 | 0.3 | 0.3 | 0.3 |
| (maximum abrasion ratio: Comparative | | | | | | | |
| Example 4 = 1) | | | | | | | |

As shown in Table 1, in the bearing in which the grease composition in each of Examples 1 to 4 was enclosed, good results were obtained in all the evaluation items of the seizure life ratio, the separation life ratio and the low-temperature fretting in spite of using the base oil having a comparatively low kinematic viscosity of 30 mm²/s (40° C.) or 50 mm²/s (40° C.). It was therefore found that it is possible to both reduce frictional resistance in a sliding part of a bearing and to maintain seizure resistance and a long-time lubrication life of the bearing, and it is also possible to reduce occurrence of fretting under a low-temperature environment.

The present application is based on a Japanese patent application No. 2015-119099 filed on Jun. 12, 2015, the contents of which are incorporated herein by reference.

### DESCRIPTION OF REFERENCE NUMERALS AND SIGNS

1: Hub unit
G: Grease

1. A grease composition comprising:
a base oil containing a poly-α-olefin and having a kinematic viscosity at 40° C. of 20 to 60 mm²/s;
a thickener containing an urea-based compound obtained by reaction of a mixed amine of an alicyclic amine and an aromatic amine with a diisocyanate compound; and
an additive,
wherein the additive contains a phosphorous acid ester, an ether-based compound, and a paraffin oxide.

2. The grease composition according to claim 1, wherein:
the base oil has a traction coefficient of 0.02 or less; and
the base oil has a pour point of −50° C. or less.

3. The grease composition according to claim 1, wherein the ether-based compound has a polar group at a molecular terminal, the polar group having a 5-membered ring including at least one hetero atom.

4. The grease composition according to claim 1, comprising the thickener in an amount of 10 mass % to 25 mass %, the phosphorous acid ester in an amount of 0.2 mass % to 5 mass %, the ether-based compound in an amount of 0.2 mass % to 5 mass %, and the paraffin oxide in an amount of 0.5 mass % to 10 mass %.

5. A rolling device for a vehicle, comprising the grease composition according to claim 1, the grease composition being enclosed as a lubricant in the rolling device.

6. The grease composition according to claim 2, wherein the ether-based compound has a polar group at a molecular terminal, the polar group having a 5-membered ring including at least one hetero atom.

7. The grease composition according to claim 2, comprising the thickener in an amount of 10 mass % to 25 mass %, the phosphorous acid ester in an amount of 0.2 mass % to 5 mass %, the ether-based compound in an amount of 0.2 mass % to 5 mass %, and the paraffin oxide in an amount of 0.5 mass % to 10 mass %.

8. The grease composition according to claim 3, comprising the thickener in an amount of 10 mass % to 25 mass %, the phosphorous acid ester in an amount of 0.2 mass % to 5 mass %, the ether-based compound in an amount of 0.2 mass % to 5 mass %, and the paraffin oxide in an amount of 0.5 mass % to 10 mass %.

9. The grease composition according to claim 6, comprising the thickener in an amount of 10 mass % to 25 mass %, the phosphorous acid ester in an amount of 0.2 mass % to 5 mass %, the ether-based compound in an amount of 0.2 mass % to 5 mass %, and the paraffin oxide in an amount of 0.5 mass % to 10 mass %.

10. A rolling device for a vehicle, comprising the grease composition according to claim 2, the grease composition being enclosed as a lubricant in the rolling device.

11. A rolling device for a vehicle, comprising the grease composition according to claim 3, the grease composition being enclosed as a lubricant in the rolling device.

12. A rolling device for a vehicle, comprising the grease composition according to claim 6, the grease composition being enclosed as a lubricant in the rolling device.

13. A rolling device for a vehicle, comprising the grease composition according to claim 4, the grease composition being enclosed as a lubricant in the rolling device.

14. A rolling device for a vehicle, comprising the grease composition according to claim 7, the grease composition being enclosed as a lubricant in the rolling device.

15. A rolling device for a vehicle, comprising the grease composition according to claim 8, the grease composition being enclosed as a lubricant in the rolling device.

16. A rolling device for a vehicle, comprising the grease composition according to claim 9, the grease composition being enclosed as a lubricant in the rolling device.
